(19) United States
(12) Patent Application Publication
(10) Pub. No.: US 2014/0372559 A1
(43) Pub. Date: Dec. 18, 2014

(54) Method for the wireless transmission of data between wireless devices compatible with multiple operating systems allowing a user to share data and links to web-based files in an ad hoc peer to peer(s) fashion.

(71) Applicant: Alan Gerard Maloney, San Francisco, CA (US)

(72) Inventor: Alan Gerard Maloney, San Francisco, CA (US)

(21) Appl. No.: 14/306,248

(22) Filed: Jun. 17, 2014

Related U.S. Application Data
(60) Provisional application No. 61/836,139, filed on Jun. 17, 2013.

(51) Int. Cl. H04L 29/08

(52) U.S. Cl. CPC H04L 67/06; H04L 67/104; H04W 84/18
USPC 709/217

(57) ABSTRACT

A method for ad hoc sharing of data in a wireless transmission fashion including, but not limited to, links to web-based files, between wireless devices compatible with multiple operating system platforms. The method includes at least the following steps: A user with the application or program on their wireless device initiates a promiscuous transmission mode and transmits computer data compatible with multiple mobile device operating systems. One or more recipient(s) accept transmission of the data which is stored in a retrievable fashion on their wireless device(s). The received data includes unique resource locator links to the application and file(s) located on the internet.

### CROSS REFERENCE

This application claims the benefit of U.S. Provisional Application No. 61/836,139, filed Jun. 17, 2013, which application is incorporated herein by reference in its entirety.

### BACKGROUND

1. Field of the Invention

The present invention is directed to a method of transmitting computer data including, but not limited to, documents, graphic files, audio files, video files, Vcard files, barcode files, positioning data, user data and links to web-based files, from one wireless network device to at least one second wireless network device in a wireless transmission fashion.

2. Description of the Related Art

The current state of the art employs operating system-specific transmission of data from one wireless network device to one or more wireless network devices in a wireless transmission fashion. [1,2,3,4,5,6]1. Method for setting wireless network devices. US 20030198191 A1. Publication number US20030198191 A1. Publication date: Oct. 23, 2003. Inventors: Ju-Fang Hsiao. Assignee: GEMTEK TECHNOLOGY CO., LTD. NO. 1, REN-Al RD., HUKOU TOWNSHIP HSINCHU COUNTY, TAIWAN 3032. Handheld wireless conferencing technology. WO 2003043301 A3. Application number PCT/US2002/035673. Publication date: Aug. 21, 2003. Inventors: Jeff Musa.3. Point to multi-point wireless video delivery. US 20110314506 A1. Publication number US20110314506 A1. Publication date: Dec. 22, 2011. Inventors: Peyush Agarwal, Yasantha N. Rajakarunanayake, Alexander G. Maclnnis, James D. Bennett, William S. Bunch, and F. Dougherty James III. Original Assignee: Broadcom Corporation.4. Bypassing bluetooth discovery for devices in a special list. US 20120164947 A1. Publication number: US20120164947 A1. Publication date: Jun. 28, 2012. Inventors: Mart T. Davis, David Kammer and Eric Klein.5. Method and apparatus for service discovery in wi-fi direct network. US 20110149806 A1.

Publication number US20110149806 A1. Publication date: Jun. 23, 2011. Inventors: Jin-woo Jeong, Il-Ju Na, Sung-Bum Park, Lochan VERMA. Original Assignee: Samsung Electronics Co., Ltd. 6. Wi-Fi Service Method and System for Wi-Fi Devices. EP 2387206 A1. Publication number EP2387206 A1. Publication date: Nov. 16, 2011. Inventors: Jong Mu Choi, Jhong Il Kim, Jun Ho Lee, Jung Hun Lee and You Na Lee.

### SUMMARY

In one embodiment of the present invention, it is provided that a single wireless device will be activated in a promiscuous mode and transmit sequentially or concurrently data to recipient device(s) compatible with their operating systems which will be stored in a retrievable fashion on the recipient devices.

In another embodiment of the present invention, it is provided that a single wireless device will be activated in a promiscuous mode, identify one or more recipient wireless devices and their operating system(s), the promiscuous device will transmit sequentially or concurrently data to the recipient device(s) compatible with their operating system(s) which will be stored in a retrievable fashion on the recipient devices.

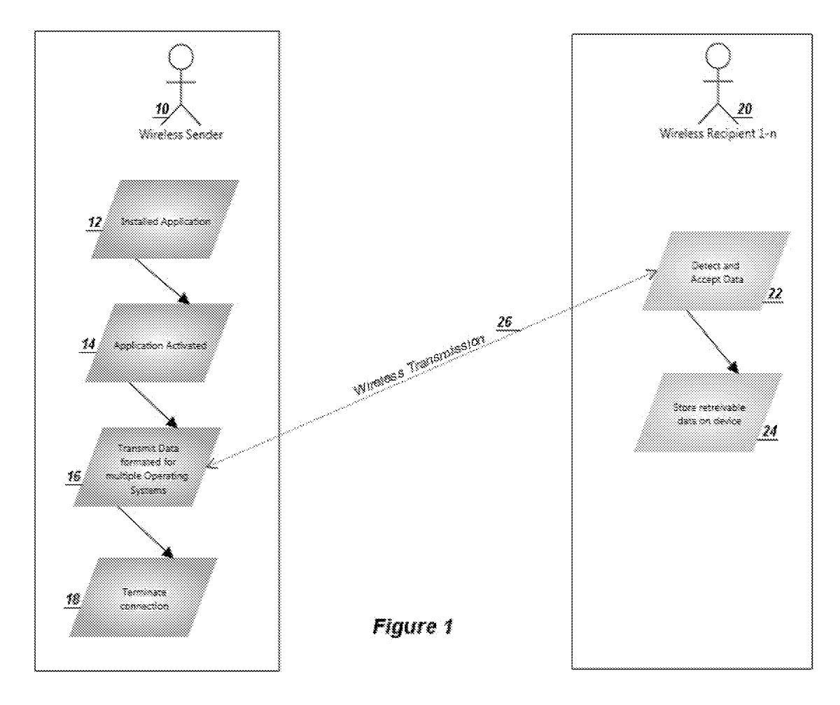

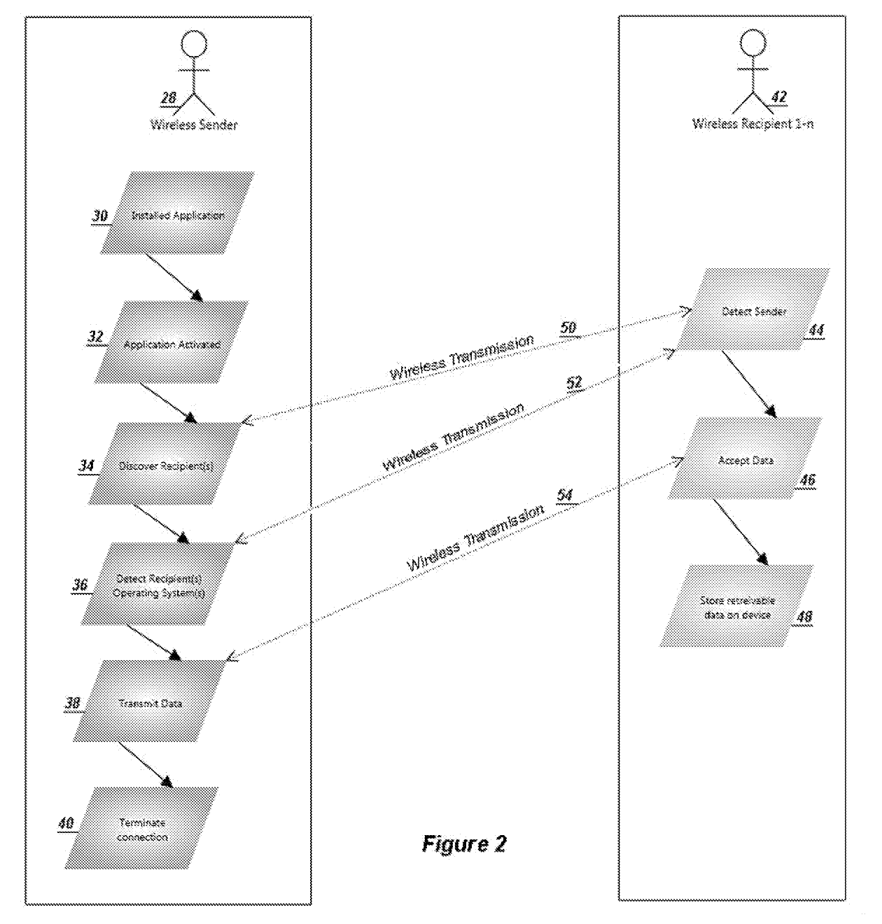

### DRAWINGS

[See Documents FIG. 1 and FIG. 2, attached]

### BRIEF DESCRIPTION OF THE DRAWINGS

In FIG. 1, a sender activates an application on a wireless device and transmits sequentially or concurrently data compatible with multiple wireless device operating systems. The recipient(s) detect and accept the wireless transmission and the data is stored in a retrievable fashion on the recipient(s) wireless device. The sender's wireless device then terminates the wireless connection.

In FIG. 2, a sender activates an application on a wireless device, sending a wireless signal to discover candidate recipient(s) in range. The sender's device discovers candidate recipients and determines their device(s)'s operating system. The recipient(s) accept the wireless connection. The sender's device transmits sequentially or concurrently data compatible with the recipient(s)'s wireless device operating system. The data is stored in a retrievable fashion on the recipient(s) wireless device. The sender's wireless device then terminates the wireless connection.

### DETAILED DESCRIPTION

The present invention describes a method for the ad hoc transmission of computer data from one wireless device to one or more wireless device(s) in a wireless transmission fashion compatible with the recipient device(s) operating system(s) which will be stored in a retrievable fashion on the recipient devices.

The invention includes a computer program or application on a sender's wireless device (FIG. 1, # 12; FIG. 2, # 30) that can be activated in a promiscuous mode to discover one or more wireless devices within range. The sender's wireless device will discover and identify recipient(s) wireless device(s).

In one embodiment of the invention illustrated in FIG. 1, a sender (# 10) wishes to wirelessly transmit data to one or more recipient(s) (# 20). The sender will activate (# 14) the computer application or program and the sender's wireless device will transmit (# 16), in a wireless transmission fashion (# 26), sequentially or concurrently, data in a fashion which is universally readable by all mobile device operating systems, or multiple versions of data compatible with one or more wireless device operating systems. The recipient(s) will accept data transmission (# 22) and the data will be stored on the recipient(s) wireless device in a retrievable fashion (# 24). Upon completion of transmission the wireless connection will be terminated.

In another embodiment of the invention illustrated in FIG. 2, a sender (# 28) wishes to wirelessly transmit data to one or more recipient(s) (# 42). The sender activates the computer application or program (# 32) and the sender's wireless device will identify one or more candidate recipient(s)'s wireless devices (# 34), identifies the operating system(s) of the recipient device(s) (# 36) and transmit data (# 38) in a format compatible with the operating system(s) of the recipient device(s). This will be done by transmitting, in a wireless transmission fashion (# 50, 52, 54), sequentially or concurrently all versions of the data required for compatibility with the operating system(s) on the recipient devices. The recipient(s) be identified by the sender (# 44), will accept data transmission (# 46) and the data will be stored on the recipient(s) wireless device in a retrievable fashion (# 48). Upon completion of transmission the wireless connection will be terminated (# 40).

The sender may activate the computer application or program on their wireless device in a variety of ways (FIG. 1, # 14; FIG. 2, # 32), including but not limited to, voice command, eye gaze, keyboard command, movement of the mobile device, tapping, swiping or otherwise contacting the device or a graphic element on the sender device's touch screen.

The recipient will accept data transmission (FIG. 1, # 22; FIG. 2, # 46) by a means such as, but not limited to, voice command, eye gaze, keyboard command, movement of the mobile device, tapping, swiping or otherwise contacting the recipient device or a graphic element on the recipient device's touch screen.

The format of the data to be transmitted (FIG. 1, # 16; FIG. 2, # 38) in a wireless fashion will be compatible with various mobile operating systems. This may be done by means of, but not limited to, detecting the operating systems of the recipient device(s) and transmitting a version of the data compatible with the identified operating system(s), by transmitting a version of the data readable by multiple operating systems, by transmitting multiple versions of the data to be readable by multiple wireless device operating systems. These multiple versions may be drawn from a default set of operating systems or selected by the sender at the creation of the data set to be transmitted or at the time of data transmission.

The duration of wireless data transmission may be set by means such as, but not limited to, communication between sender and recipient(s) wireless devices confirming completion of data transmission, a pre-specified period of time, a duration preset by the sender or by response from recipient(s) such as, but not limited to, voice command, eye gaze, keyboard command, movement of the mobile device, tapping, swiping or otherwise contacting the recipient device or a graphic element on the recipient device's touch screen.

Termination of transmission (FIG. 1, # 18; FIG. 2, # 40) will come at the end of the duration of transmission.

The data transmitted and saved in a retrievable manner will include (FIG. 1, # 24; FIG. 2, # 48), but not be limited to; graphical elements including, but not limited to, icon(s), photograph(s) or video elements; text including, but not limited to, instructions, name of service name of sender, identification of data set transmitted, original author(s) of data set, directions, user agreement, copyright agreement; sound or audio files; Vcard files; barcode files; positioning data; user data; one or more unique resource locator which can be used to directly link to the application or program on the internet, and or directly link to full or expanded versions of computer files referenced to or included in the data set transmitted in a wireless fashion.

The application or program for the wireless transmission of data between wireless devices compatible with multiple operating system platforms will reside in the wireless devices of senders (FIG. 1, # 12; FIG. 2, # 30) and be available for download and installation into wireless device from the internet.

What is claimed is:

1. A method for the wireless transmission of data between wireless devices compatible with multiple operating systems allowing a user to share data and links to web-based files in an ad hoc peer to peer(s) fashion comprising:
a. A computer program or application on a sender's wireless device; and
b. One or more recipient wireless devices

2. The method described in claim 1 wherein the sender activates the computer application or program and the sender's wireless device will transmit, in a wireless transmission fashion sequentially, data in a fashion which is universally readable by all mobile device operating systems. The recipient(s) will accept data transmission and the data will be stored on the recipient(s) wireless device in a retrievable fashion. Upon completion of transmission the wireless connection will be terminated.

3. The method described in claim 1 wherein the sender activates the computer application or program and the sender's wireless device will transmit, in a wireless transmission fashion concurrently, data in a fashion which is universally readable by all mobile device operating systems. The recipient(s) will accept data transmission and the data will be stored on the recipient(s) wireless device in a retrievable fashion. Upon completion of transmission the wireless connection will be terminated.

4. The method described in claim 1 wherein the sender activates the computer application or program and the sender's wireless device will transmit, in a wireless transmission fashion sequentially, multiple versions of data compatible with one or more wireless device operating systems. The recipient(s) will accept data transmission and the data will be stored on the recipient(s) wireless device in a retrievable fashion. Upon completion of transmission the wireless connection will be terminated.

5. The method described in claim 1 wherein the sender activates the computer application or program and the sender's wireless device will transmit, in a wireless transmission fashion concurrently, multiple versions of data compatible with one or more wireless device operating systems. The recipient(s) will accept data transmission and the data will be stored on the recipient(s) wireless device in a retrievable fashion. Upon completion of transmission the wireless connection will be terminated.

6. The method described in claim 1 wherein the sender activates the computer application or program and the sender's wireless device identifies one or more candidate recipient(s)'s wireless devices and identifies the operating system(s) of the recipient device(s) and transmit data in a format compatible with the operating system(s) of the recipient device(s). This will be done by transmitting, in a wireless transmission fashion, sequentially all versions of the data required for compatibility with the operating system(s) on the recipient devices. The recipient(s) identified by the sender, will accept data transmission and the data will be stored on the recipient(s) wireless device in a retrievable fashion. Upon completion of transmission the wireless connection will be terminated.

7. The method described in claim 1 wherein the sender activates the computer application or program and the sender's wireless device identifies one or more candidate recipient(s)'s wireless devices and identifies the operating system(s) of the recipient device(s) and transmit data in a format compatible with the operating system(s) of the recipient device(s). This will be done by transmitting, in a wireless transmission fashion, concurrently all versions of the data required for compatibility with the operating system(s) on the recipient devices. The recipient(s) identified by the sender, will accept data transmission and the data will be stored on the recipient(s) wireless device in a retrievable fashion. Upon completion of transmission the wireless connection will be terminated.

8. An information system for the wireless transmission of data between wireless devices compatible with multiple operating systems allowing a user to share data and links to web-based files in an ad hoc peer to peer(s) fashion comprising:
a. A computer program or application on a sender's wireless device; and
b. One or more recipient wireless devices

9. The information system described in claim 8 wherein the sender activates the computer application or program and the sender's wireless device will transmit, in a wireless transmission fashion sequentially, data in a fashion which is universally readable by all mobile device operating systems. The recipient(s) will accept data transmission and the data will be stored on the recipient(s) wireless device in a retrievable fashion. Upon completion of transmission the wireless connection will be terminated.

10. The information system described in claim 8 wherein the sender activates the computer application or program and the sender's wireless device will transmit, in a wireless transmission fashion concurrently, data in a fashion which is universally readable by all mobile device operating systems. The recipient(s) will accept data transmission and the data will be stored on the recipient(s) wireless device in a retrievable fashion. Upon completion of transmission the wireless connection will be terminated.

11. The information system described in claim 8 wherein the sender activates the computer application or program and the sender's wireless device will transmit, in a wireless transmission fashion sequentially, multiple versions of data compatible with one or more wireless device operating systems. The recipient(s) will accept data transmission and the data will be stored on the recipient(s) wireless device in a retrievable fashion. Upon completion of transmission the wireless connection will be terminated.

12. The information system described in claim 8 wherein the sender activates the computer application or program and the sender's wireless device will transmit, in a wireless transmission fashion concurrently, multiple versions of data compatible with one or more wireless device operating systems. The recipient(s) will accept data transmission and the data will be stored on the recipient(s) wireless device in a retrievable fashion. Upon completion of transmission the wireless connection will be terminated.

13. The information system described in claim 8 wherein the sender activates the computer application or program and the sender's wireless device identifies one or more candidate recipient(s)'s wireless devices and identifies the operating system(s) of the recipient device(s) and transmit data in a format compatible with the operating system(s) of the recipient device(s). This will be done by transmitting, in a wireless transmission fashion, sequentially all versions of the data required for compatibility with the operating system(s) on the recipient devices. The recipient(s) identified by the sender, will accept data transmission and the data will be stored on the recipient(s) wireless device in a retrievable fashion. Upon completion of transmission the wireless connection will be terminated.

14. The information system described in claim 8 wherein the sender activates the computer application or program and the sender's wireless device identifies one or more candidate recipient(s)'s wireless devices and identifies the operating system(s) of the recipient device(s) and transmit data in a format compatible with the operating system(s) of the recipient device(s). This will be done by transmitting, in a wireless transmission fashion, concurrently all versions of the data required for compatibility with the operating system(s) on the recipient devices. The recipient(s) identified by the sender, will accept data transmission and the data will be stored on the recipient(s) wireless device in a retrievable fashion. Upon completion of transmission the wireless connection will be terminated.
While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention
